(19) United States
(12) Patent Application Publication
(10) Pub. No.: US 2025/0233508 A1
(43) Pub. Date: Jul. 17, 2025

(54) ELECTRONIC DEVICE AND METHOD FOR CONTROLLING, WITH SUPPRESSION OF AT LEAST ONE ENERGIZING PHASE, AN ELECTRICAL ENERGY CONVERTER COMPRISING A PIEZOELECTRIC RESONATOR, ASSOCIATED ELECTRICAL ENERGY CONVERSION SYSTEM

(71) Applicant: Commissariat à l’énergie atomique et aux énergies alternatives, Paris (FR)

(72) Inventors: Lucas Henrique DE ARAUJO PEREIRA, Grenoble Cedex (FR); Ghislain DESPESSE, Grenoble Cedex (FR); Adrien MOREL, Grenoble Cedex (FR); Gaël PILLONNET, Grenoble Cedex (FR)

(73) Assignee: Commissariat à l’énergie atomique et aux énergies alternatives, Paris (FR)

(21) Appl. No.: 18/986,280

(22) Filed: Dec. 18, 2024

(30) Foreign Application Priority Data
Dec. 19, 2023 (FR) FR2314512

(51) Int. Cl. H02M 1/088; H02M 1/00; H02M 3/00

(52) U.S. Cl. CPC H02M 1/088; H02M 1/0003; H02M 3/01

(57) ABSTRACT

A system, method, and device for driving a converter including two input terminals, two output terminals, a piezoelectric resonator, and a plurality of switches connected to the resonator, a first switch being connected between an input terminal and the resonator and switchable between an open position and a closed position where an input voltage is applied to the resonator. The device includes a module for measuring an output variable, a module for controlling a switching of the switches to alternate phases with a substantially constant voltage and a substantially constant load at the terminals of the resonator, and a module for detecting a characteristic event dependent on the output variable. In the event of detection of the event, the control module commands the first switch into the open position for the duration of at least one resonance cycle.

The present invention relates to an electronic device for driving an electric energy converter apt to convert an input voltage into an output voltage.

The invention further relates to an electrical energy conversion system comprising such a converter and such an electronic device for driving the converter.

The present invention further relates to a method for driving such a converter.

A converter with two input terminals for receiving the input voltage, two output terminals for delivering the output voltage, a piezoelectric resonator with two terminals, and a plurality of switches connected to the piezoelectric resonator, is known.

An electronic driving device is known, comprising a measurement module configured to measure an output variable of the converter; and a control module configured to control a switching of each of the switches, to alternate phases with a substantially constant voltage at the terminals of the piezoelectric resonator and phases with a substantially constant load at the terminals of said piezoelectric resonator.

The most interesting feature of such type of converter is the high power density thereof when same operates at a few MHz. Thereof is due to the mechanical and piezoelectric property of the transient energy storage element, which makes it possible to reduce the size thereof in a linear manner with the increase in the power density, while the inductance exhibits a reduction with a lower rate, as described in the article by P. A. Kyaw and C. R. Sullivan, “Fundamental examination of multiple potential passive component technologies for future power electronics” 2015 IEEE 16th Workshop on Control and Modeling for Power Electronics (COMPEL).

Control strategies, i.e. driving strategies, of DC-to-DC (Direct current-Direct current) converters with a six-phase piezoelectric resonator during a resonance cycle, with alternation of phases with a substantially constant voltage at the terminals of the resonator and phases with a substantially constant load at the terminals of the resonator, are described in the following articles:
J. J. Piel, J. D. Boles, J. H. Lang and D. J. Perreault, “Feedback Control for a Piezoelectric-Resonator-Based DC-DC Power Converter” 2021 IEEE 22nd Workshop on Control and Modelling of Power Electronics (COMPEL);
B. Pollet, G. Despesse and F. Costa, “A New Non-Isolated Low-Power Inductorless Piezoelectric DC-DC Converter” in IEEE Transactions on Power Electronics, vol. 34, no. 11; and
M. Touhami, G. Despesse, F. Costa and B. Pollet, “Implementation of Control Strategy for Step-down DC-DC Converter Based on Piezoelectric Resonator” 2020 22nd European Conference on Power Electronics and Applications (EPE'20 ECCE Europe).

Such strategies respond rather well but have a limit when the power requested at the output of the converter drops suddenly. Such abrupt power drop may occur e.g. if the load changes mode, e.g. to go to standby, but also at the end of start-up when the output voltage reaches the target voltage. The piezoelectric resonator has an oscillation amplitude which depends on the current requested, a current I_{L} internal to the resonator being all the higher as the output current Iₒᵤₜ is high. The amplitude of the mechanical movement cannot be abruptly lowered, and power continues to be supplied to the output, even though the target output voltage is already reached, which leads to an overvoltage.

To overcome such effect, the document FR 3 125 182 A1 proposes to bring in a reactive power by extending one of the voltage levels by a first half-period over a second half-period of the resonance cycle, so that said level sees an outgoing current and then a return current. Thereby, either part of the energy supplied by the input voltage to the resonator is returned to the input, or part of the energy supplied to the output is returned to the resonator, or both, depending on the level that is extended. Said method is interesting, but requires the driving of an additional angle as well as the management of an energy storage.

The article by E. A. Stolt, W. D. Braun and J. M. Rivas-Davila, “Forward-Zero Cycle Closed-Loop Control of Piezoelectric Resonator DC-DC Converters” 2022 IEEE 23rd Workshop on Control and Modeling for Power Electronics (COMPEL), describes a regulation in the voltage burst mode maintaining a fixed frequency operation with substantially constant control angles, but short-circuiting the resonator periodically during a complete resonance cycle so as to adjust the output power of the converter. For example, by removing one resonance cycle in five, the output power no longer sees any power for one resonance period in five and the energy supplied to the resonator is also reduced, limiting the amplitude of the current in the resonator and hence the power transmitted over the other four periods. Such method works but requires the driving of a block of a plurality of resonance cycles, i.e. a plurality of resonance periods, e.g. five resonance periods, because the adjustment of the current is no longer carried out at the scale of the period, but of said plurality of periods. In addition to the difficulty of predicting the switching instants over the multiple periods, it is moreover necessary to have at the output a filtering over said plurality of periods, which reduces the reactivity of the converter, and increases the size of passive filtering elements.

The goal of the invention is then to propose an electronic control device, and an associated control method, leading to improved driving of the electric energy converter.

To this end, the subject matter of invention is an electronic device for driving an electric energy converter apt to convert an input voltage into an output voltage, the converter including two input terminals for receiving the input voltage, two output terminals for delivering the output voltage, a piezoelectric resonator having two terminals, and a plurality of switches connected to the piezoelectric resonator; one of the switches, called a first switch, being connected between one of the input terminals and the piezoelectric resonator, the first switch being switchable between an open position and a closed position wherein the input voltage is applied at the terminals of the piezoelectric resonator;
the electronic driving device comprising:
   a measuring module configured to measure an output variable of the converter;
   a control module configured to control a switching of each of the switches to alternate substantially constant voltage phases at the terminals of the piezoelectric resonator and substantially constant load phases at the terminals of the piezoelectric resonator;
   a detection module configured to detect at least one characteristic event dependent on the measured output variable;
the control module being configured, upon detection of the at least one characteristic event, to command the first switch into the open position for at least one resonance cycle of the piezoelectric resonator.

With the electronic control device according to the invention, the control—in the event of detection of the at least one characteristic event—of the first switch in the open position for the duration of one or a plurality of successive resonance cycles of the piezoelectric resonator serves to remove the phase of the resonance cycle during which the input voltage is applied to the terminals of the piezoelectric resonator, i.e. to remove the phase of supplying energy to the piezoelectric resonator, also called energizing phase.

The removal of the energizing phase during one or a plurality of successive resonant cycles of the piezoelectric resonator, i.e. during one or a plurality of successive resonant periods, then serves to rapidly reduce the total energy in the piezoelectric resonator and, consequently, at the output of the converter, without losing the synchronization between the driving device and the vibrations of the piezoelectric resonator.

In other words, by preventing an addition of energy from the piezoelectric resonator during the entire duration of at least one resonance cycle, or even during the entire duration of a plurality of successive resonance cycles, the energy stored in the piezoelectric resonator decreases rapidly, which makes it possible to remedy the detected event.

Preferably, the detected event which is remedied is an over-energy event, when the measured output variable is greater than a threshold variable.

In a variant, or in addition, the detected event which is remedied is a so-called minimum energy event, when the measured output variable is greater than a target variable and the duration during which the first switch is in the closed position during a respective resonance cycle has decreased to a minimum duration, and can then no longer decrease further. The minimum energy event then corresponds to the case where the energizing phase is at the minimum duration thereof, and cannot be shortened further to further reduce the addition of energy to the piezoelectric resonator, and at the same time the output variable is already greater than the desired target variable.

According to other advantageous aspects of the invention, the electronic control device comprises one or a plurality of the following features, taken individually or according to all technically possible combinations:
the at least one characteristic event includes an over-energy event, detected when the measured output variable is greater than a threshold variable;
the at least one characteristic event includes a minimum energy event, detected when the measured output variable is greater than a target variable and the time during which the first switch is in the closed position during a respective resonance cycle is less than or equal to a minimum duration;
the threshold variable is greater than the target variable.
the threshold variable is preferably equal to a multiple of the target variable, the multiple being between 1.02 and 1.3;
the multiple preferably being comprised between 1.02 and 1.1; more preferably equal to 1.05;
the output variable is the output voltage;
the control module is configured to command the first switch in the open position for the duration of a plurality of successive resonant cycles of the piezoelectric resonator;
the control module is configured to command the first switch into the open position as long as the at least one characteristic event is detected;
the piezoelectric resonator includes one of the constitutions from the group consisting of: a single piezoelectric element; a plurality of piezoelectric elements connected in series; a plurality of piezoelectric elements connected in parallel; a piezoelectric element and an auxiliary capacitor connected in series; a piezoelectric element and an auxiliary capacitor connected in parallel; and an arrangement of a plurality of parallel branches, each branch including one or a plurality of piezoelectric elements connected in series or an auxiliary capacitor.
the auxiliary capacitor preferably having a capacitance greater than, and more preferably at least three times greater than, a reference capacitance of the piezoelectric element or elements, each piezoelectric element being modeled in the form of a capacitor and a resonant branch connected in parallel with the capacitor, the reference capacitance being the capacitance of said capacitor.

The invention further relates to an electrical energy conversion system:
an electrical energy converter including two input terminals for receiving the input voltage, two output terminals for delivering the output voltage, a piezoelectric resonator having two terminals, and a plurality of switches connected to the piezoelectric resonator; one of the switches, called first switch, being connected between one of the input terminals and the piezoelectric resonator, the first switch being switchable between an open position and a closed position wherein the input voltage is applied at the terminals of the piezoelectric resonator; and
an electronic driving device for each electric energy converter; the electronic driving device being as defined hereinabove.

The invention further relates to an method for driving an electric energy converter apt to convert an input voltage into an output voltage, the converter including two input terminals for receiving the input voltage, two output terminals for delivering the output voltage, a piezoelectric resonator having two terminals, and a plurality of switches connected to the piezoelectric resonator; one of the switches, called first switch, being connected between one of the input terminals and the piezoelectric resonator, the first switch being switchable between an open position and a closed position wherein the input voltage is applied at the terminals of the piezoelectric resonator;
the method being implemented by an electronic driving device and comprising the following steps:
   measurement of an output variable of the converter;
   controlling a switching of each of the switches to alternate substantially constant voltage phases at the terminals of the piezoelectric resonator and substantially constant load phases at the terminals of the piezoelectric resonator;
the method further comprising the following step:
   detection of at least one characteristic event dependent on the measured output variable;
the control step including, in the event of detection of the at least one characteristic event, a control of the first switch in the open position for the duration of at least one resonance cycle of the piezoelectric resonator.

Such features and advantages of the invention will become clearer upon reading the following description, given only as a non-limiting example, and made with reference to the enclosed drawings, wherein:

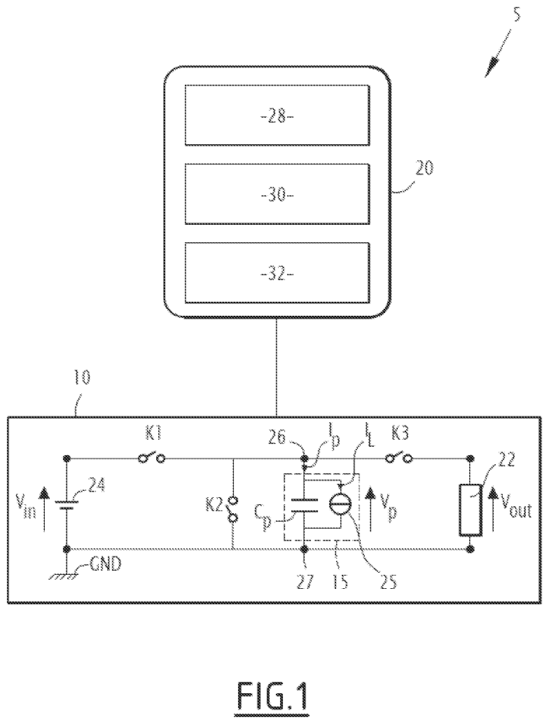

FIG. 1 is a schematic representation of an electronic system for converting electrical energy according to the invention, comprising an electrical energy converter including a piezoelectric resonator and a plurality of switches connected to the piezoelectric resonator; and an electronic device for driving the electrical energy converter;

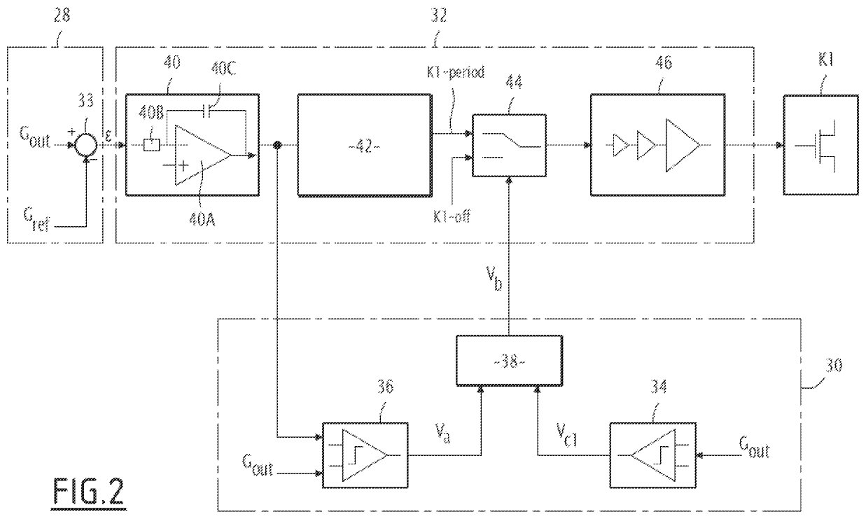

FIG. 2 is a schematic representation of the driving device in FIG. 1;

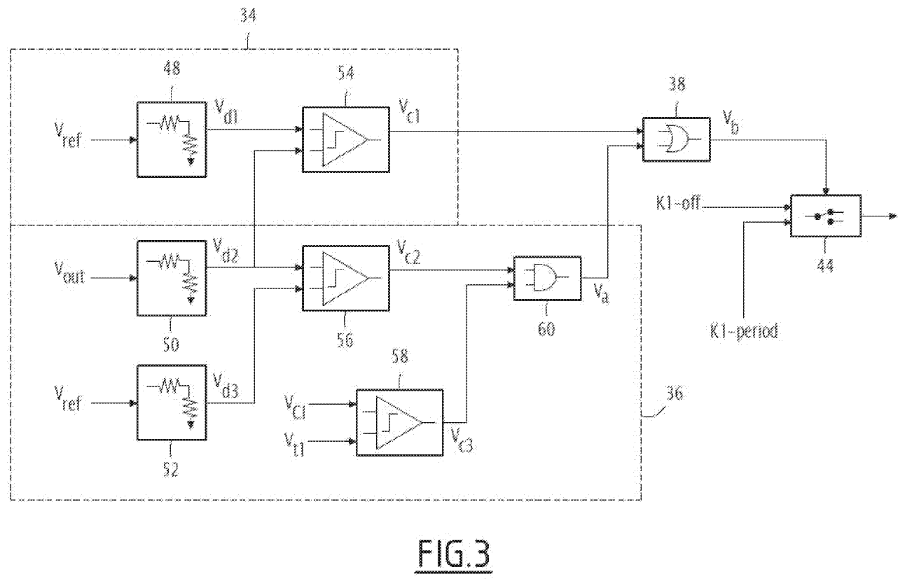

FIG. 3 is a view similar to FIG. 2 schematically showing in detail a unit for detecting a minimum energy event and a unit for detecting an over-energy event, included in the driving device of FIGS. 1 and 2;

FIG. 4 is an organization chart of a method according to the invention, for driving an electrical energy converter, the method being implemented by the driving device shown in FIG. 1;

FIG. 5 shows curves of the voltage and current at the terminals of the piezoelectric resonator shown in FIG. 1, in voltage step-up mode, and voltage step-down mode, of the electric energy converter; and

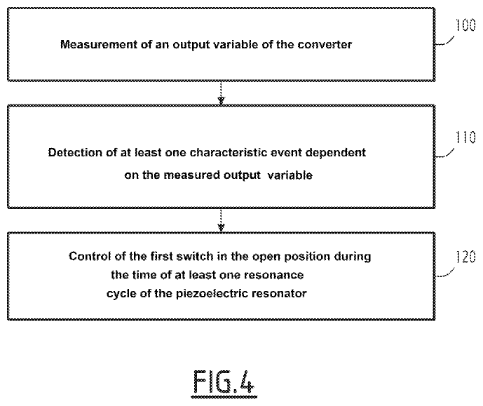

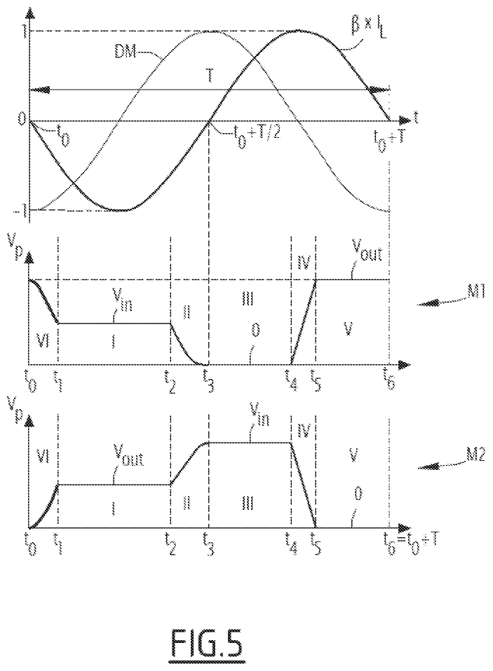

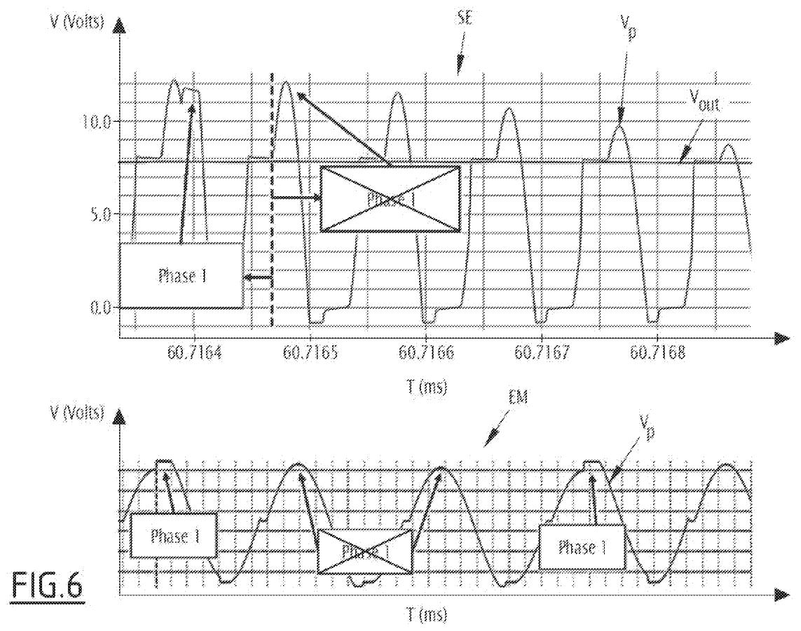

FIG. 6 shows the curve of the voltage at the terminals of the piezoelectric resonator of FIG. 1, in the event of detection of the minimum energy event or the over-energy event, leading to the removal of a phase (at substantially constant voltage) of addition of energy to the piezoelectric resonator.

In FIG. 1, an electrical energy conversion system 5 comprises an electrical energy converter 10 including a piezoelectric resonator 15 and a plurality of switches K1, K2, K3 connected to the piezoelectric resonator 15; and an electronic device 20 for driving the electric energy converter 10. The electrical energy is typically a voltage, or, in a variant, a current or a power.

The electrical energy conversion system 5 is typically a DC electrical energy conversion system, such as a DC-DC conversion system apt to convert a first DC electrical energy received at the input into a second DC electrical energy delivered at the output, or else an AC-DC conversion system apt to convert an AC electrical energy received at the input into a DC electrical energy delivered at the output of the conversion system 5.

When the electrical energy conversion system 5 is an AC-DC conversion system, the electrical energy conversion system 5 preferentially further comprises a voltage rectifier (not shown) connected to the input of the electric energy converter 10 and apt to rectify the alternating electric voltage received at the input of the conversion system 5 so as to deliver a rectified electric voltage at the input of the converter 10, the electrical energy converter 10 being preferentially a DC-DC converter apt to convert a DC electrical energy into another DC electrical energy. The voltage rectifier is e.g. a rectifier bridge, such as a diode bridge. In a variant, the voltage rectifier is formed, in full or in part, by switches of the converter 10, e.g. via bidirectional voltage switches.

The skilled person would observe that the different examples for the conversion system 5, whether it is a DC-DC conversion system or an AC-DC conversion system, are also presented in documents FR 3 086 471 A1 and FR 3 086 472 A1, in particular with reference to FIGS. 1 to 3, 10, 15, 17 and 19 to 20.

The electrical energy converter 10 is preferentially a DC-DC converter. The purpose of the DC-DC converter is generally to regulate a supply voltage Vₒᵤₜ of a load 22 to a stable variable, by being supplied by a power source 24 supplying a substantially DC voltage Vin. The power source 24 is e.g. a battery or a solar panel.

The electrical energy converter 10 is then configured for raising the value of the DC voltage between the input thereof and the output thereof, and is then also called step-up DC-DC converter, or else a strongly step-up DC converter; or is configured for lowering the value of the DC voltage between the input thereof and the output thereof, and is then called step-down DC-DC converter, with also as a variant a strongly step-down DC-DC converter.

When the electrical energy converter 10 is a step-down DC-DC converter, the value of the input voltage typically corresponds to the voltage Vᵢₙ of the energy source 24, and the value of the output voltage corresponds to the voltage Vₒᵤₜ at the terminals of the load 22, the voltage Vin then being greater than the voltage Vₒᵤₜ.

When the electrical energy converter 10 is a step-up DC-DC converter, the value of the input voltage also typically corresponds to the voltage Vᵢₙ of the energy source 24, and the value of the output voltage corresponds to the voltage Vₒᵤₜ at the terminals of the load 22, the voltage Vᵢₙ then being less than the voltage Vₒᵤₜ.

When the electrical energy converter 10 is a strongly step-down DC-DC converter, the value of the input voltage corresponds, e.g., to the voltage difference (Vᵢₙ−Vₒᵤₜ), and the variable of the output voltage corresponds, e.g., to the voltage Vₒᵤₜ, the voltage difference (Vᵢₙ−Vₒᵤₜ) being markedly greater than the voltage Vₒᵤₜ.

When the electrical energy converter 10 is a step-down DC-DC converter, according to a step-down variant, the value of the input voltage corresponds e.g. to the voltage difference (Vᵢₙ−Vₒᵤₜ), and the value of the output voltage corresponds to the voltage Vₒᵤₜ at the terminals of the load 22, the voltage difference (Vᵢₙ−Vₒᵤₜ) being greater than the voltage Vₒᵤₜ.

The electrical energy converter 10 includes the piezoelectric resonator 15 and the driving device 20 is configured for operating the piezoelectric material of the piezoelectric resonator 15 at the resonance thereof in order to exploit phases of load transfer which make it possible to dispense with the use of an inductive element, while regulating the output voltage while maintaining the resonance of the piezoelectric material, i.e. with repeated switching cycles at an operating frequency which is dependent on the resonance frequency of the piezoelectric resonator 15, and adjusting the times between the respective switchings within the resonance cycle.

As is known per se, the mechanical oscillation of the piezoelectric resonator 15 is approximately sinusoidal. An increase or decrease in stored energy over a period leads to an increase or decrease in oscillation amplitude, respectively. Moreover, during a phase with a substantially constant load at the terminals of the piezoelectric resonator 15, i.e. when the piezoelectric resonator 15 are placed in a substantially open electrical circuit, with a small exchange of electrical loads between the piezoelectric resonator 15 and the outside, an increase in the amplitude of the oscillations leads to an increase in the rate of variation of the voltage Vₚ at the terminals the piezoelectric resonator 15, and during a phase with a substantially constant voltage at the terminals of the piezoelectric resonator 15, such increase in oscillation amplitude leads to an increase in the current exchanged the piezoelectric resonator 15 and the outside.

“Substantially constant load” refers to an exchange of a load with the outside which is less than 30% of the load which would have been exchanged with the outside if the voltage would have been kept constant. In other words, “substantially constant load” refers to a load variation of less than 30% of the load which would have been exchanged with the outside of the piezoelectric resonator 15 if the voltage at the terminals of the piezoelectric resonator 15 would have been kept constant over the time period considered.

“Substantially open electrical circuit” refers to a circuit the possible leakage current of which leads to a variation in the load of the piezoelectric resonator 15 of less than 30% of the load which would have been exchanged with the outside of the piezoelectric resonator 15 if the voltage at the terminals of the resonator 15 would have been kept constant over the length of time considered.

“Substantially constant voltage” refers to a voltage variation of less than 20%, preferentially less than 10%, of the input or output voltage of the converter 10. As an example, if the input voltage of the converter 10 is equal to 100 V, then the voltage variation during each phase with substantially constant voltage, i.e. at each substantially constant voltage step, is less than 20% of said voltage, i.e. less than 20 V; preferentially less than 10% of said voltage, i.e. less than 10 V.

The converter 10 then includes a plurality of switches K1, K2, K3 apt to be controlled to alternate phases with a substantially constant voltage and phases with a substantially constant load at the terminals of the piezoelectric resonator 15. Such alternation of phases at substantially constant voltage and phases at substantially constant load is typically carried out within periods of substantially constant duration corresponding to the operating frequency of the converter 10, depending on an oscillation frequency, also called natural frequency, of the piezoelectric resonator 15. The phases with a substantially constant load make it possible, in the steady state, to switch from one constant voltage to another and to close the switches which have to be closed when the voltage across same is preferentially zero in order to have a so-called zero-voltage switching (ZVS).

Each switch of the converter 10, namely a first switch K1, a second switch K2 and, in addition, a third switch K3, comprises e.g. a transistor and an antiparallel diode (not shown) intrinsic to the transistor.

The transistor is e.g. an insulated gate field effect transistor, also called MOSFET (Metal Oxide Semiconductor Field Effect Transistor). In a variant, the transistor 50 is a bipolar transistor; an insulated gate bipolar transistor, also called IGBT (Insulated Gate Bipolar Transistor); a silicon (Si) transistor, a GaN (Gallium Nitride) transistor; a silicon carbide (SiC) transistor, a diamond transistor, or a thyristor or further mechanical switch such as micro-switch such as a MEMS (MicroElectroMechanical System).

The first switch K1 is connected between one of the input terminals and the resonator 15, the first switch K1 being switchable between an open position and a closed position wherein the input voltage Vin is applied at the terminals of the resonator 15.

The second switch K2 is connected to the terminals of the piezoelectric resonator 15, the second switch K2 being switchable between an open position and a closed position wherein the voltage is zero at the terminals of the resonator 15.

The third switch K3 is connected between one of the output terminals and the resonator 15, the third switch K3 being switchable between an open position and a closed position wherein energy from the resonator 15 is given back to the output voltage Vₒᵤₜ.

The oscillation frequency is the frequency at which the resonator 12, such as the piezoelectric resonator 15, oscillates and consequently the current I_{L} thereof on the motive branch (branch R-L-C) thereof of the equivalent model thereof around the selected resonance mode. The current I_{L} can be deduced either by observing the change of the voltage Vₚ when the resonator is isolated or by observing the output current Iₚ thereof during phases at constant voltage. The conversion cycle is synchronized to a mechanical movement of the piezoelectric resonator 15, and the frequency of the control is then adjusted according to the mechanical oscillation frequency. In practice, the oscillation frequency depends on the operating point of the converter 10: values of the three voltage steps and of the output current. As a function of the operating point, the oscillation frequency typically varies between the so-called series resonance frequency of the piezoelectric element (ωs=1√(LC) where L and C correspond to the inductance and the capacitance of the resonant branch 25 descried hereinafter) and the so-called parallel resonance frequency of the piezoelectric element (ωp=1/(L*C*Cp/(C+Cp))), also called resonance frequency and antiresonance frequency, respectively, of the piezoelectric resonator 15. The operating frequency of the converter 10 is then comprised between the two resonant and anti-resonant frequencies of the piezoelectric resonator 15. The operating point varies slowly with respect to the oscillation frequency of the piezoelectric resonator 15. The operating point typically evolves at less than 10 kHz, whereas the oscillation frequency of the piezoelectric resonator 15 is typically greater than or equal to 100 kHz. As a result, the operating frequency of the converter 10 varies little from one period to the next.

The total number of phases with substantially constant voltage and with substantially constant load at the terminals of the piezoelectric resonator 15 during a resonance cycle is generally greater than or equal to one in a nominal operating mode of the converter 10. In the example shown in FIG. 1, the total number of phases is equal to six in the nominal operating mode of the converter 10.

The piezoelectric resonator 15 is known per se, and is typically modeled, close to the resonant mode used, in the form of a capacitor Cp and a resonant branch 25 connected in parallel with the capacitor Cp, the capacitor Cp and the resonant branch 25 being connected between first 26 and second 27 electrodes of the piezoelectric resonator 15. The first electrode 26 and the second electrode 27 form the terminals of the piezoelectric resonator 15.

In the example shown in FIG. 1, the piezoelectric resonator 15 further includes a single piezoelectric element.

In a variant (not shown), the piezoelectric resonator 15 includes a plurality of piezoelectric elements connected in series. In a variant, the piezoelectric resonator 15 includes a plurality of piezoelectric elements connected in parallel. In a variant, the piezoelectric resonator 15 includes a piezoelectric element and an auxiliary capacitor connected in series. In a variant, the piezoelectric resonator 15 includes a piezoelectric element and an auxiliary capacitor connected in parallel. In another variant, the piezoelectric resonator 15 includes an arrangement of plurality of parallel branches, each branch including one or a plurality of piezoelectric elements connected in series or an auxiliary capacitor.

According to the variants concerned, the auxiliary capacitor advantageously has greater capacitance, else preferably at least three times greater, than a reference capacitance of the piezoelectric element or elements, such as the capacitance of capacitor Cp in the example shown in FIG. 1, each piezoelectric element being modeled in the form of a capacitor and of a resonant branch connected in parallel of the capacitor, the reference capacitance being the capacitance of said capacitor.

In the example shown in FIG. 1, the first switch K1 is connected between a positive input terminal and the first electrode 26 of the resonator 15, the second switch K2 is connected between the first electrode 26 and the second electrode 27 of the piezoelectric resonator 15, and the third switch K3 is connected between the first electrode 26 of the resonator 15 and a positive output terminal and the resonator 15. The skilled person would understand that a positive terminal is the terminal which is at the highest potential of the input voltage Vᵢₙ, respectively of the output voltage Vₒᵤₜ. In the example shown in FIG. 1, the negative input and output terminals are connected to an electrical ground GND.

The resonant branch 25 is typically an RLC branch formed by an auxiliary capacitor, a resistor and an inductor connected in series (not shown). The voltage Vₚ across the piezoelectric element 15 then typically corresponds to the voltage across the capacitor Cp.

The capacitance of the auxiliary capacitor is advantageously greater than the capacitance of the capacitor Cp, in particular at least three times greater.

The driving device 20 comprises a measuring module 28, a detection module 30 and a control module 32.

The measuring module 28, the detection module 30, and the control module 32 are each produced e.g. in the form of an electronic circuit including one or a plurality of electronic components, and in particular comparators when comparisons are made.

In a variant, the measuring module 28, the detection module 30, the control module 32 is each produced in the form of a programmable logic component, such as an FPGA (Field Programmable Gate Array), or in the form of an integrated circuit, such as an ASIC (Application Specific Integrated Circuit) or in the form of a computer, such as a microcontroller, a processor. In another variant, the measuring module 28, the detection module 30 and the control module 32 are implemented together within a single hardware component, such as a single programmable logic component, a single integrated circuit, or a single computer.

The measuring module 28 is configured to measure an output variable G_{reg}. The output variable Gₒᵤₜ is e.g. the output voltage Vₒᵤₜ. In a variant, the output variable Gₒᵤₜ is an output current Iₒᵤₜ. In another variant, the output variable Gₒᵤₜ is an output power Pₒᵤₜ.

The detection module 30 is configured to detect at least one characteristic event depending on the measured output variable Gₒᵤₜ. The detection module 30 is advantageously apt to detect an over-energy event and/or a minimum energy event. In other words, a respective characteristic event is advantageously the over-energy event, or the minimum energy event.

The over-energy event is detected when the output variable Gₒᵤₜ, such as the output voltage Vₒᵤₜ, is greater than a threshold variable Gₜₕᵣ.

The minimum energy event is detected when the output variable Gout, such as the output voltage Vₒᵤₜ, is greater than a target variable Gₜₐᵣ and a duration D_{K1} during which the first switch K1 is in the closed position during a respective resonance cycle, has decreased to a minimum duration Dₘᵢₙ.

The threshold variable Gₜₕᵣ is typically greater than the target variable Gₜₐᵣ. The skilled person would observe that the target variable Gₜₐᵣ then forms a second threshold variable, distinct from the threshold variable Gₜₕᵣ, and preferably less than the threshold variable Gₜₕᵣ.

Advantageously, the threshold variable Gₜₕᵣ is equal to a multiple of the target variable Gₜₐᵣ. The multiple is typically comprised between 1.02 and 1.3; preferably comprised between 1.02 and 1.1; else preferably equal to 1.05.

The converter 10 has a low power limit, characteristic of the elements forming the energy converter 10. The minimum duration Dₘᵢₙ then depends on the low power limit, since the minimum duration Dₘᵢₙ indeed cannot tend toward zero. The minimum duration Dₘᵢₙ is e.g. on the order of 2 nanoseconds.

The control module 32 is configured to control the switching of each of the switches K1, K2 and K3, typically so as to alternate substantially constant voltage phases at the terminals of the piezoelectric resonator 15 and substantially constant load phases at the terminals of the piezoelectric resonator 15.

The control module 32 is, according to the invention, configured, upon detection of the at least one characteristic event, to command the first switch K1 into the open position for at least one resonance cycle of the piezoelectric resonator 15. The first switch K1 is advantageously commanded to remain in the open position as long as at least one characteristic event is detected by the detection module 30. In other words, the first switch K1 is advantageously controlled and then maintained in the open position as long as the presence of the at least one characteristic event is detected.

As can be seen in FIG. 2 illustrating an example of the driving device 20, the measuring module 28 includes an adder 33 connected to the output of a unit (not shown), for measuring the output variable Gₒᵤₜ. The detection module 30 includes a first unit 34 for detecting the over-energy event, a second unit 36 for detecting the minimum energy event and an OR logic gate 38. The control module 32 includes a corrector 40, a generator 42 of a control signal, a multiplexer 44 and a unit 46 for driving a switch, such as the first switch K1.

The adder 33 is apt to receive both the output variable Gₒᵤₜ, such as the output voltage Vₒᵤₜ, and a reference variable G_{ref}, such as a reference voltage V_{ref}, and then to output an error B corresponding to the difference between the output variable Gₒᵤₜ and the reference variable G_{ref}. The adder 33 is typically configured to subtract the reference variable G_{ref} from the output variable Gₒᵤₜ.

The first unit 34 for detecting the over-energy event is apt to receive at the input thereof, the output variable Gₒᵤₜ, such as the output voltage Vₒᵤₜ, and of delivering at the output thereof a voltage V_{c1}, the voltage V_{c1} typically being in the form of a square wave voltage with a high or low logic level depending on whether or not the over-energy event has been detected.

The second unit 36 for detecting the minimum energy event is connected to the output of the corrector 40. The second detection unit 36 is also apt to receive at input the output variable Gₒᵤₜ, such as the output voltage Vₒᵤₜ, and to deliver at output a voltage Vₐ, the voltage Vₐ typically also being in the form of a square wave voltage with a high or low logic level depending on whether or not the minimum energy event has been detected.

The OR logic gate 38 is connected at the output of the first unit 34 and of the second unit 36, and is then apt to receive at the input the voltage V_{c1} and the voltage Vₐ.

The OR logic gate 38 is apt to deliver a voltage V_{b} at output, the voltage V_{b} typically also being in the form of a square wave voltage with a high logic level if the voltages V_{c1} and Vₐ have a high logic level, and with a low logic level otherwise.

The corrector 40 is typically configured to regulate the output variable Gₒᵤₜ with respect to the reference variable G_{ref}, by receiving at the input thereof the error B coming from the adder 33, corresponding to the output variable Gₒᵤₜ minus the reference variable G_{ref}, and by then performing an integration of the error B.

The corrector 40 comprises e.g. an operational amplifier 40A, an electrical resistor 40B and a feedback loop with a capacitor 40C. The feedback loop connects the output of operational amplifier 40A to the negative input thereof. The electrical resistor 40B is connected between the input of the corrector 40 receiving the voltage E and the negative input of the operational amplifier 40A. It is of course understood that other types of correctors 40 can be used.

The control signal generator 42 is connected to the output of the corrector 40 and is configured to generate a periodic control signal for the first switch K1 denoted by K1-period as a function of the signal at the output of the corrector 40.

The multiplexer 44 is connected at the output of the generator 42 and of the OR logic gate 38, and is then able to receive at the input the control signals for opening K1-off and periodic closing K1-period, as well as the voltage V_{b}.

The multiplexer 44 is e.g. apt to select the opening control signal K1-off if the voltage V_{b} has a high logic level, and of not selecting a control signal, in particular if the voltage V_{b} has a low logic level.

The driving unit 46 is connected to the output of the multiplexer 44 and then able to receive at the input the control signal in opening K1-off or in periodic closing K1-period, respectively, coming from the multiplexer 44.

The driving unit 46 is connected at the input of the first switch K1, and is configured to apply the control signal either of opening and holding open K-off, or of periodic closing K1-period, to a control electrode of the first switch K1, such as a gate electrode when the switch K1 includes a transistor such as a MOSFET or an IGBT.

In the example shown in FIG. 3, the first unit 34 for detecting the over-energy event comprises a first voltage divider 48 and a first comparator 54.

In the example shown in FIG. 3, the second unit 36 for detecting the minimum energy event comprises a second voltage divider 50, a third voltage divider 52, a second comparator 56, a third comparator 58 and an AND logic gate 60.

The voltage dividers 48, 50, 52 are typically configured to deliver an output voltage lower than the input voltage thereof. The first voltage divider 48 is apt to receive at input the reference variable G_{ref}, such as the reference voltage V_{ref}, and apt to deliver at output a voltage V_{d1}, the voltage V_{d1} being a fraction of the input voltage V_{ref}.

The second voltage divider 50 is apt to receive at the input thereof the output variable Gₒᵤₜ, such as the output voltage Vₒᵤₜ, and apt to deliver at the output thereof a voltage V_{d2}, the voltage V_{d2} being a fraction of the input voltage Vₒᵤₜ.

The third voltage divider 52 is apt to receive at input the reference variable G_{ref}, such as the reference voltage V_{ref}, and apt to deliver at output a voltage V_{d3}, the voltage V_{d3} being a fraction of the input voltage V_{ref}.

The division factors implemented by the first, second and third voltage dividers 48, 50, 52, respectively, are such that, on the one hand, the ratio between the voltages V_{d2} and V_{d3} is equal to the ratio between the output variable Gₒᵤₜ and the target variable Gₜₐᵣ, in particular equal to the ratio between the output voltage Vₒᵤₜ and a target voltage Vₜₐᵣ; and, on the other hand, that the ratio between the voltages V_{d2} and V_{d1} is equal to the ratio between the output variable Gₒᵤₜ and the threshold variable Gₜₕᵣ, in particular equal to the output voltage Vₒᵤₜ and a threshold voltage Vₜₕᵣ.

The first comparator 54 is connected at the output of the first voltage divider 48 and a second voltage divider 50, and then apt to receive at the input the voltage V_{d1} and a voltage V_{d3}.

The first comparator 54 is apt to deliver a voltage V_{c1} at output, the voltage V_{c1} typically also being in the form of a square wave voltage with a high logic level if the voltages V_{d2} is greater than the voltage V_{d1}, and with a low logic level otherwise.

The second comparator 56 is connected at the output of the second voltage divider 50 and of the third voltage divider 52, and then apt to receive at the input the voltage V_{d2} and the voltage V_{d3}.

The second comparator 56 is apt to deliver a voltage V_{c2} at output, the voltage V_{c2} typically also being in the form of a square wave voltage with a high logic level if the voltages V_{d2} is greater than the voltage V_{d3}, and with a low logic level otherwise.

The third comparator 58 is apt to receive at input a voltage V_{Cl} and a voltage Vₜ₁. The voltage V_{Cl} is a voltage related to the minimum duration Dₘᵢₙ and the voltage Vₜ₁ is a voltage related to the duration D_{K1} of closure of the switch K1 during the respective cycle, the voltages V_{Cl} and Vₜ₁ being chosen so that the ratio between the voltages Vₜ₁ and V_{Cl} is equal to the ratio between the durations D_{K1} and Dₘᵢₙ.

The third comparator 58 is apt to deliver a voltage V_{c3} at output, the voltage V_{c3} typically also being in the form of a square wave voltage with a high logic level if the voltages Vₜ₁ becomes smaller than the voltage V_{Cl}, and with a low logic level otherwise.

The AND logic gate 60 is connected at the output of the second comparator 56 and of a third comparator 58, and is then apt to receive at the input the voltage V_{c2} and a voltage V_{c3}.

The AND logic gate 60 is apt to deliver a voltage Vₐ at output, the voltage Vₐ typically also being in the form of a square wave voltage with a high logic level if the voltages V_{c2} and V_{c3} have a high logic level, and with a low logic level otherwise.

The nominal operation of a cycle of the converter 10 will now be described with reference to FIG. 5 showing the successive phases of a resonance cycle of the piezoelectric resonator, according to a generic format corresponding to different operating modes of the converter 10, namely a first mode of operation M1, also called voltage step-up mode; and a second mode of operation M2, also called voltage step-down mode.

The different phases correspond to steady-state or permanent operation of the converter 10, i.e. from the moment when the resonance of the piezoelectric material is reached with a substantially constant amplitude, and then with substantially balanced energy and charge exchanges over each period T of the resonance cycle. To simplify the description, losses in the on-state switches, as well as losses in the piezoelectric material at resonance, are neglected.

FIG. 5 then shows the change of the current β*1L of the amplitude-normalized current IL flowing through the piezoelectric resonator 15; of the voltage Vₚ at the terminals of the piezoelectric resonator 15; and of the mechanical deformation of the piezoelectric resonator 15, represented by the curve DM; thereof during a resonance cycle and for two operating modes of the converter 10, namely the first operating mode M1 as a voltage step-up, and the second operating mode m2 as a voltage step-down. With β=−1 in voltage step-up mode M1; and β=+1 in voltage step-down mode M2.

By convention, a first switching time instant, denoted by t₁, corresponds to the closing of the first switch K₁ for the first mode M1, respectively of the third switch K₃ for the second mode M2, and the voltage Vₚ at the terminals of the piezoelectric resonator 15 is then substantially constant and equal to the input voltage Vᵢₙ according to the first mode M1, or to the output voltage Vₒᵤₜ according to the second mode M2. At the first switching time t₁ then starts a first phase I until the opening of the switch which has been closed at the first switching time t₁.

A second switching time instant, denoted by t₂, corresponds to the opening of the first switch K₁ for the first mode M1, respectively of the third switch K₃ for the second mode M2, and the voltage Vₚ at the terminals of the piezoelectric resonator 15 then passes from a preceding voltage Vᵢₙ according to the first mode M1, or Vₒᵤₜ according to the second mode M2, to an open circuit position. At the second switching time instant t₂ then begins a second phase 11 lasting up to a time instant t₃ corresponding to a passage through zero of the current I_{L} circulating in the piezoelectric resonator 15. Beforehand, the time instant t₂ has been defined so that, at the time instant t₃, the voltage Vₚ across the terminals of the piezoelectric resonator 15 reaches a value making it possible to switch the corresponding switch to zero voltage.

At the time instant t₃, a third phase 111 begins at a substantially constant voltage, at the zero variable according to the first mode M1 via the closing of the second switch K2, or at the input voltage Vᵢₙ according to the second mode M2 via the closing of the first switch K₁, and lasts until a time instant t₄ which forms an adjustment parameter of the converter 10, the time instant t₄ making it possible to define the voltage, the current or else the desired power at the output of the converter 10.

The time instant t₄ then corresponds to the end of the third phase 111 and to the instant at which the second switch K₂ according to the first mode M1, or the first switch K₁, respectively according to the second mode M2, has then to be open, the time instant t₄ forming a fourth switching time instant corresponding to the opening of the second switch K₂ according to the first mode M1, or respectively of the first switch K₁ according to the second mode M2.

A fourth phase IV starts at the fourth switching time t1, corresponding to a phase with substantially constant load, or else in substantially open circuit, the fourth phase IV lasting until a time instant t₅ defined by the passage to a new predefined variable of the voltage Vₚ at the terminals of the piezoelectric resonator 15. When the converter 10 includes three switches K₁, K₂, K₃ apt to be controlled to alternate phases at substantially constant voltage and phases at substantially constant charge at the terminals of the piezoelectric resonator 15, the time instant t₅ forming the end of the fourth phase IV typically corresponds to the closing of the third switch K₃ according to the first mode M1, or of the second switch K₂, respectively, according to the second mode M2, the time instant t₅ then forming a fifth switching time.

A fifth phase V starts then at the time instant t₅, corresponding to a phase with a substantially constant voltage at the output voltage Vₒᵤₜ according to the first mode M1 via the closing of the third switch K3, or to the zero value according to the second mode M2 via the closing of the second switch K2. The fifth phase V lasts until a time instant t₀, or else until a time instant t₆ modulo the period T of the resonance cycle defined by the passage through zero of the current I_{L} circulating in the piezoelectric resonator 15, and according to a monotonic change opposite to the monotonic change of the passage through zero at the time instant t₃. By convention, the time instant t₆ is equal to the sum of the time instant to and the period T of the resonance cycle, and is also denoted by (t₀+T).

In the example shown in FIG. 5, the time instant tₑ corresponds to the end of a resonance cycle of the piezoelectric resonator 15, the cycle represented having been defined with respect to the time instants of the passage through zero of the current I_{L} flowing in the piezoelectric resonator 15, and not with respect to the first switching time instant t₁.

The time instant t₀, or else the time instant t₆, is obtained via the opening of the third switch K₃ according to the first mode M1, or of the second switch K2, respectively, according to the second mode M2, and then forms a sixth switching time instant.

From the passage through zero of the current I_{L} flowing through the piezoelectric resonator 15 then begins a sixth phase VI corresponding to a phase with substantially constant charge, the sixth phase VI flowing between the time instant tₑ and the time instant t₆+t₁, or again between the time instant to and the time instant t₁ in the example of FIG. 5, with the proviso that the time instant t₆ corresponds to the time instant t₀ to within a resonance cycle. The end of the sixth phase VI corresponds to the moment when the voltage Vₚ at the terminals of the piezoelectric resonator 15 reaches the input voltage Vᵢₙ according to the first mode M1, or to the output voltage Vₒᵤₜ according to the second mode M2.

Furthermore, the skilled person would observe that the phase during which the electrical energy is transferred to the piezoelectric resonator 15, also called the energizing phase of the cycle, is the phase corresponding to the closing of the first switch K1, i.e. the first phase I according to the first operating mode M1, and to the third phase Ill, respectively, according to the second operating mode M2. The energizing phase ends with the opening of the first switch K1 at the time instant t₂ according to the first mode M1, and at the time instant t₄, respectively, according to the second mode M2. The time instant of opening of the first switch K1, and more generally the duration of the energizing phase, is defined as the time instant enabling the piezoelectric resonator 15 to receive a quantity of energy equal to the quantity of energy collected by the output load 22 during the period T.

The method of driving the electrical converter 10 during the detection of the at least one event characteristic according to the invention will now be described with reference to the flowchart shown in FIG. 4, the method comprising three distinct steps.

During a first step 100, the measuring module 28 of the driving device 20 measures the output variable Gₒᵤₜ, such as the output voltage Vₒᵤₜ, of the converter 10 at the terminals of the load 22.

During the second step 110, the detection module 30 then detects at least one characteristic event depending on the measured output variable Gₒᵤₜ.

The at least one characteristic event may be the over-energy event and/or the minimum energy event.

The detection of the over-energy event will now be described.

The detection module 30 receives the output variable Gₒᵤₜ measured by the measuring module 28. The over-energy event is detected within the first unit 34. As an example, when the output variable Gₒᵤₜ is the output voltage Vₒᵤₜ, at the output of the first voltage divider 48 and of the second voltage divider 50, the voltages V_{d1} and V_{d2} are compared within the first comparator 54. If the voltage V_{d2} coming from the second divider bridge 50 receiving the output voltage Vₒᵤₜ is greater than the voltage V_{d1}, representative of the threshold voltage Vₜₕᵣ, the over-energy event is detected by the first comparator 54, and the voltage V_{c1} at the output of the first comparator 54 then has a high logic level.

The over-energy event is thus detected if the output variable Gₒᵤₜ is greater than the threshold variable Gₜₕᵣ.

The detection of the minimum energy event will now be described.

The detection module 30 receives the output variable Gₒᵤₜ measured by the measuring module 28. The minimum energy event is detected within the second unit 36. As an example, when the output variable Gₒᵤₜ is the output voltage Vₒᵤₜ, at the output of the second voltage divider 50 and of the third voltage divider 52, the voltages V_{d2} and V_{d3} are compared within the second comparator 56. If the voltage V_{d2} coming from the second divider bridge 50 receiving the output voltage Vₒᵤₜ is greater than the voltage V_{d3}, representative of the target voltage Vₜₐᵣ, then the voltage V_{c2} at the output of the second comparator 56 has a high logic level. Furthermore, the voltages V_{Cl} and Vₜ₁ are also compared within the third comparator 58. If the voltage Vₜ₁ related to the duration D_{K1} of closure of the switch K1 becomes less than or equal to the voltage V_{C1} related to the minimum duration Dₘᵢₙ, then the voltage V_{c3} at the output of the third comparator 58 also has a high logic level. In such case, the AND logic gate 60 thus also has a high logic level at the output thereof which corresponds to the detection of the minimum energy event.

The minimum energy event is then detected if the output variable Gₒᵤₜ is greater than the target variable Gₜₐᵣ and if the duration D_{K1} of closure of the switch K1 is less than or equal to the minimum duration Dₘᵢₙ.

The presence of a high level on one of the voltages V_{c1} or Vₐ generates the presence of a high level on the voltage V_{b} which corresponds to the detection of at least one characteristic event. Such detection, in the form of the voltage V_{b} at the high level, is then transmitted to the control module 32, and more particularly to the multiplexer 44.

During step 120, and when the voltage V_{b} is at the high level, corresponding to the detection of the at least one characteristic event, the multiplexer 44 then selects the opening control signal K1-off. During the duration of at least one resonance cycle of the piezoelectric resonator 15, the first switch K1 will then be forced into the open position, i.e. maintained in the open position. The electrical converter 10 is thus no longer in the nominal operating mode thereof, and changes to a particular operating mode during which the number of phases is reduced by one unit, in particular with one less phase with a substantially constant voltage, and is typically equal to 5 for the electrical converter 10 of the example shown FIG. 1.

In such particular mode of operation, the removed phase is the energizing phase of the electrical resonator 15, typically the first phase I according to the first mode of operation M1, and the third phase Ill, respectively, according to the second mode of operation M2.

In other words, when at least one characteristic event is detected by the detection module 30, the control module 32 removes the energizing phase by controlling the opening of the first switch K1 as long as the detection module 30 detects the presence of the at least one characteristic event, where the removal of the energizing phase could be consecutive over a plurality of cycles, as shown in FIG. 6.

FIG. 6 shows the curve of the voltage Vₚ at the terminals of the piezoelectric resonator 15, on the one hand for a first example—denoted by SE—of detection of the over-energy event, and on the other hand for a second example EM of detection of the minimum energy event.

The skilled person would then observe that in the first example of over-energy SE, from the moment when the over-energy event is detected by the detection module 30, corresponding to the vertical line in dotted lines, the energizing phase, such that the first phase I, also denoted as phase 1, is removed during a plurality of successive resonance cycles of the piezoelectric resonator 15, and during at least five successive cycles in the first example SE, until the output variable Gₒᵤₜ again becomes less than the threshold G thr.

In the second example of minimum energy EM, the energizing phase, such as the first phase I, also denoted phase 1, is also removed during a plurality of successive resonance cycles of the piezoelectric resonator 15, in such case during two successive cycles, and the converter 10 then returns to nominal operating mode. The skilled person would understand that in the second example, the converter returns to nominal operating mode as soon as the minimum energy event is no longer detected, i.e. as soon as the output variable Gₒᵤₜ again becomes less than the target variable Gₜₐᵣ.

It should thereby be understood that the electronic driving device 20 and the driving method according to the invention lead to improved driving of the electric energy converter 10.

The skilled person would further understand that, according to the invention, in the event of detection of the at least one characteristic event, the control module 32 is configured to command the first switch K1 in the open position for the duration of at least one resonance cycle of the piezoelectric resonator 15, while not modifying during said duration the control of the other switches K2, K3 connected to the piezoelectric resonator 15.

In other words, during said duration, only the control of the first switch K1 is modified to keep the first switch K1 in the open position, while the control of the other switches K2, K3 is unchanged, at least with respect to the preceding resonance cycle of the piezoelectric resonator.

The invention then corresponds to the superimposition of an exception state, namely the command of the first switch K1 into the open position during said duration in the event of detection of the at least one characteristic event, on a normal regulated operating state.

On the other hand, in the prior art, if the control law is temporarily modified for the first switch, it is also modified for the other switches, which means changing cycles or sequences, without continuing the normal cycle corresponding to the normal regulated operating state.

1-10. (canceled)

11. An electronic device for driving an electric energy converter apt to convert an input voltage into an output voltage, the converter including two input terminals for receiving the input voltage, two output terminals for delivering the output voltage, a piezoelectric resonator having two terminals, and a plurality of switches connected to the piezoelectric resonator, one of the switches, called first switch, being connected between one of the input terminals and the piezoelectric resonator, the first switch being switchable between an open position and a closed position wherein the input voltage is applied at the terminals of the piezoelectric resonator, the electronic device comprising:
a measuring module configured to measure an output variable of the converter;
a control module configured to control a switching of each of the switches, to alternate substantially constant voltage phases at the terminals of the piezoelectric resonator and substantially constant load phases at the terminals of the piezoelectric resonator; and
a detection module configured to detect at least one characteristic event depending on the measured output variable,
the control module being configured to, upon detection of the at least one characteristic event, command the first switch into the open position for at least one resonance cycle of the piezoelectric resonator.

12. The device according to claim 11, wherein the at least one characteristic event includes an over-energy event detected when the measured output variable is greater than a threshold variable.

13. The device according to claim 11, wherein the at least one characteristic event includes a minimum energy event detected when the measured output variable is greater than a target variable and a duration during which the first switch in the closed position during a respective resonance cycle is less than or equal to a minimum duration.

14. The device according to claim 13, wherein the at least one characteristic event includes an over-energy event detected when the measured output variable is greater than a threshold variable, and wherein the threshold variable is greater than the target variable.

15. The device according to claim 14, wherein the threshold variable is equal to a multiple of the target variable, the multiple being comprised between 1.02 and 1.3.

16. The device according to claim 14, wherein the multiple is comprised between 1.02 and 1.1.

17. The device according to claim 14, wherein the multiple is equal to 1.05.

18. The device according to claim 11, wherein the output variable is the output voltage.

19. The device according to claim 11, wherein the control module is configured to command the first switch into the open position for a duration of successive resonant cycles of the piezoelectric resonator.

20. The device according to claim 11, wherein the control module is configured to command the first switch into the open position as long as the at least one characteristic event is detected.

21. The device according to claim 11, wherein the piezoelectric resonator includes one of the constitutions from the group consisting of:
a single piezoelectric element;
a plurality of piezoelectric elements connected in series;
a plurality of piezoelectric elements connected in parallel;
a piezoelectric element and an auxiliary capacitor connected in series;
a piezoelectric element and an auxiliary capacitor connected in parallel; and
an arrangement of a plurality of parallel branches, each branch including one or a plurality of piezoelectric elements connected in series or an auxiliary capacitor.

22. The device according to claim 21, wherein the auxiliary capacitor has a capacitance greater than a reference capacitance of the piezoelectric element or elements, each piezoelectric element being modeled in a form of a capacitor and a resonant branch connected in parallel with the capacitor, the reference capacitance being the capacitance of the capacitor.

23. An electrical energy conversion system comprising:
an electric energy converter having two input terminals for receiving the input voltage, two output terminals for delivering the output voltage, a piezoelectric resonator having two terminals, and a plurality of switches connected to the piezoelectric resonator, one of the switches, called first switch, being connected between one of the input terminals and the piezoelectric resonator, the first switch being switchable between an open position and a closed position wherein the input voltage is applied at the terminals of the piezoelectric resonator; and
the electronic device for driving the electric energy converter according to claim 11.

24. A method for driving an electric energy converter apt to convert an input voltage into an output voltage, the converter including two input terminals for receiving the input voltage, two output terminals for delivering the output voltage, a piezoelectric resonator having two terminals, and a plurality of switches connected to the piezoelectric resonator, one of the switches, called first switch, being connected between one of the input terminals and the piezoelectric resonator, the first switch being switchable between an open position and a closed position wherein the input voltage is applied at the terminals of the piezoelectric resonator, the method being implemented by an electronic device and comprising:
measuring an output variable of the converter;
controlling a switching of each of the switches, to alternate substantially constant voltage phases at the terminals of the piezoelectric resonator and substantially constant load phases at the terminals of the piezoelectric resonator; and
detecting at least one characteristic event dependent on the measured output variable, wherein
the controlling includes, in event of detection of the at least one characteristic event, a command of the first switch into the open position for a duration of at least one resonance cycle of the piezoelectric resonator.
